(19) United States
(12) Patent Application Publication
(10) Pub. No.: US 2025/0214251 A1
(43) Pub. Date: Jul. 3, 2025

(54) PALLETIZING METHOD FOR UNKNOWN INCOMING MATERIALS, CONTROL DEVICE AND COMPUTER-READABLE STORAGE MEDIUM

(71) Applicant: UBTECH ROBOTICS CORP LTD, Shenzhen (CN)

(72) Inventors: Wenzhou Li, Shenzhen (CN); Chunyu Chen, Shenzhen (CN); Mingqi Gao, Shenzhen (CN); Pengyu Zou, Shenzhen (CN); Pei Dong, Shenzhen (CN); Huan Tan, Shenzhen (CN)

(21) Appl. No.: 18/898,655

(22) Filed: Sep. 26, 2024

(30) Foreign Application Priority Data
Dec. 28, 2023 (CN) 202311848231.3

(51) Int. Cl. B25J 9/16; G06T 7/50; G06T 7/60; G06T 7/70

(52) U.S. Cl. CPC B25J 9/1697; G06T 7/50; G06T 7/60; G06T 7/70

(57) ABSTRACT

A palletizing method includes: detecting, by one or more depth cameras, a stacking pattern on a pallet; generating a height map matrix based on the stacking pattern, wherein a value at each element of a plurality of elements in the height map matrix indicates a height of the stacking pattern at a position on the pallet corresponding to the element; for each box of the one or more boxes: traversing the elements in the height map matrix to obtain a mask matrix generated based on hypothetical situations that a target vertex of the box rests on a position corresponding to each of the elements; determining reward function values corresponding to one or more of elements in the mask matrix with an element value of 1; determining a box number and a box placement posture corresponding to a largest reward function value of the reward function values.

### CROSS REFERENCE TO RELATED APPLICATIONS

This application claims priority to Chinese Patent Application No. CN 202311848231.3, filed Dec. 28, 2023, which is hereby incorporated by reference herein as if set forth in its entirety.

### TECHNICAL FIELD

The present disclosure generally relates to robots, and in particular relates to a palletizing method for unknown incoming materials, control device and computer-readable storage medium.

### BACKGROUND

Palletizing robots are typically employed at the end of factory production lines to handle products packed in fixed-size boxes on the conveyor belt, placing them one by one in order onto a pallet. Typically, robotic arm manufacturers provide software with palletizing algorithms, allowing users to input the size of incoming materials and specify the stacking order and logic for each layer. The robotic arms will then execute the palletizing task reliably and accurately.

However, the conventional robotic arms are applicable for only boxes of fixed size. In the logistics industry, the sizes of incoming boxes are often inconsistent, which can lead to mixed palletizing and result in unstable box placement on the pallet.

Therefore, there is a need to provide a palletizing method for unknown incoming materials to overcome the above-mentioned problem.

### BRIEF DESCRIPTION OF DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawings, all the views are schematic, and like reference numerals designate corresponding parts throughout the several views.

FIG. 1 is a schematic diagram of a palletizing system for unknown incoming materials according to one embodiment.

FIG. 2 is an exemplary flowchart of a palletizing method for unknown incoming materials according to one embodiment.

FIG. 3 is a schematic diagram of boxes on a pallet and the 3D model generated based on images of the boxes on a pallet captured by a depth camera.

FIG. 4 is a schematic diagram of a height map matrix.

FIG. 5 is an overall flowchart a palletizing method according to one embodiment.

FIG. 6 is an exemplary flowchart of a method implemented by a planning module according to one embodiment.

FIG. 7 is a schematic diagram of a palletizing device according to one embodiment.

FIG. 8 is a schematic diagram of a control device of the palletizing system according to one embodiment.

### DETAILED DESCRIPTION

The disclosure is illustrated by way of example and not by way of limitation in the figures of the accompanying drawings, in which like reference numerals indicate similar elements. It should be noted that references to “an” or “one” embodiment in this disclosure are not necessarily to the same embodiment, and such references can mean “at least one” embodiment.

Although the features and elements of the present disclosure are described as embodiments in particular combinations, each feature or element can be used alone or in other various combinations within the principles of the present disclosure to the full extent indicated by the broad general meaning of the terms in which the appended claims are expressed.

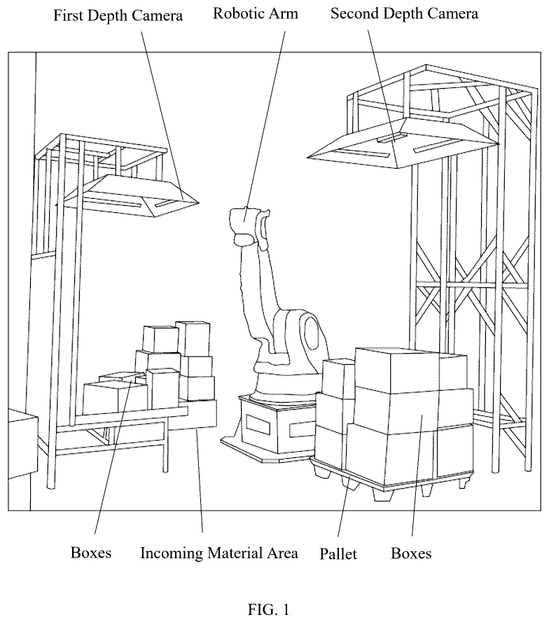

Referring to FIG. 1, in one embodiment, a palletizing system for unknown incoming materials may include one or more depth cameras 101, a control device 102, and a robotic arm 103. The one or more depth cameras 101 and the robotic arm 103 are electrically connected to the control device 102. The control device 102 can be an x86 industrial control computer. The robotic arm 103 can be electrically connected to the control device 102 through a PLC communication module and a robotic arm controller, which allows the control device 102 to communicate with and control the robotic arm 103.

The one or more depth cameras are to perceive the incoming material area (simulating the material buffer zone) and the pallet area. On one hand, the one or more depth cameras detect the size and quantity of the boxes in the incoming material area, and on the other hand, the one or more depth cameras sense the stacking pattern on the pallet. In one embodiment, as shown in FIG. 1, two depth cameras are employed: one for the incoming material area, and the other one for the pallet area.

The control device 102 is to generate a height map matrix based on the stacking pattern. The value at each element of a number of elements in the height map matrix indicates a height of the stacking pattern at a position on the pallet corresponding to the element. The control device 102 is further to traverse the boxes in the incoming material area, and for each box of the one or more boxes: traverse the elements in the height map matrix to obtain a mask matrix generated based on hypothetical situations that a target vertex of the box rests on a position corresponding to each of the elements. Array dimensions of the mask matrix and the height map matrix are the same. The control device 102 is further to determine reward function values corresponding to one or more of elements in the mask matrix with an element value of 1. The element value being 1 indicates that first constraint conditions are satisfied when the target vertex of the box rests on a position corresponding to one of the elements in the height map matrix. The control device 102 is further to determine a box number and a box placement posture corresponding to a largest reward function value of the reward function values. The control device 102 is further to control the robotic arm 103 to perform palletizing according to the box number and the box placement posture.

In summary, the palletizing system uses depth cameras for sensing, use an industrial robotic arm as an actuating mechanism, and use intelligent algorithms for palletizing decision-making and motion planning. While ensuring the stability of the stacking, the system places boxes from the conveyor belt onto the pallet, aiming to maximize space utilization.

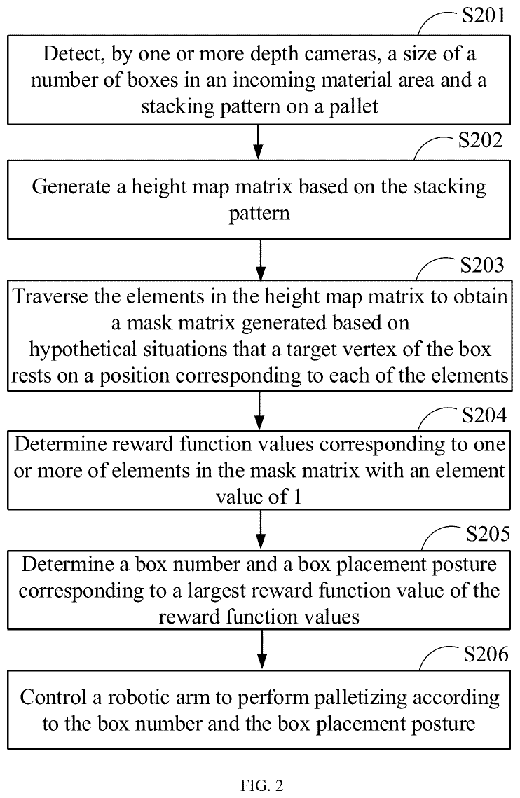

Referring to FIG. 2, in one embodiment, a palletizing method for unknown incoming materials may include the following steps. The method may be implemented by the control device 102 discussed above.

Step S201: Detect, by one or more depth cameras, a size of a number of boxes in an incoming material area and a stacking pattern on a pallet.

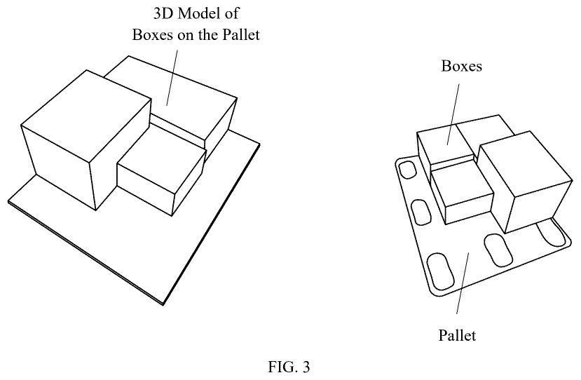

In one embodiment, two depth cameras are employed. One depth camera is used for detecting the size and quantity of the boxes in the incoming material area, and the other depth camera is used for sensing the stacking pattern on the pallet. As shown in FIG. 3, the sub-figure on the right shows several boxes actually stacked on the pallet. The control device 102 converts the two-dimensional depth map captured by one of the depth cameras into a three-dimensional model expressed by voxels. This three-dimensional model is helpful for analyzing problems with the palletizing planning algorithm during the debugging phase.

Step S202: Generate a height map matrix based on the stacking pattern.

The value at each element of a number of elements in the height map matrix indicates a height of the stacking pattern at a position on the pallet corresponding to the element. In other words, the height map matrix is a two-dimensional array of distance values measured from the pallet to the top of the uppermost boxes on the pallet.

The raw data of the depth camera above the pallet is a depth map. The resolution of the depth map is related to the resolution of the depth camera. The depth camera sends the depth map to the control device 102. The control device 102 uses a palletizing algorithm to convert the stacking pattern into a height map matrix. The palletizing algorithm requires a smaller matrix dimension. The specific conversion method involves depth value filtering, using height averaging to reduce resolution, and edge sharpening.

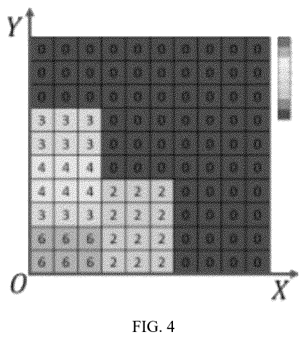

The value of each element in the height map matrix represents the height value of the pallet pattern at that position corresponding to the element, but the height value is voxelized, which is convenient for the subsequent decision algorithm to determine whether a group of points with close heights nearby belong to the same contour surface. FIG. 4 is a schematic diagram of the height map matrix, where 0 means that the height at that location is 0, that is, there is no box at that location, and 2 means that the total height of the box(es) at that location is 2.

The control device 102 assigns numbers the boxes in the incoming material area as Box 1, Box 2, Box 3, and so on. The control device 102 further executes steps 203 to 204 for each of the boxes in the incoming material area.

Step S203: Traverse the elements in the height map matrix to obtain a mask matrix generated based on hypothetical situations that a target vertex of the box on a position corresponding to each of the elements, wherein array dimensions of the mask matrix and the height map matrix are the same.

In one embodiment, the boxes are all rectangular, and any vertex of the box can be set as the target vertex. For example, the lower left vertex when the box is in the incoming material area is set as the target vertex. In a hypothetical situation when the target vertex of the box rests a position corresponding to an element in the height map matrix and the box meets the first constraint conditions, the element value of the element will be set to 1. If the box does not meet the first constraint conditions, the element value of the element will be set to 0. The element value being 1 indicates that the box is feasible to be placed at this position, and the element value being 0 indicates that it is not feasible to place the box at this position.

In one embodiment, the first constraint conditions may include: a stacking pattern stability after placement of the box exceeding a stability threshold, the box being reachable by the robotic arm, and no colliding between the robotic arm and the boxes on the pallet when the robotic arm is placing the box on the pallet. The stacking pattern stability specifically includes the following: the box does not interfere with the surrounding boxes, the box does not exceed the edge limit of the pallet, the box has a contact rate of more than 75% with the bottom surface. Only when the first constraint conditions are met, the element value will be set to 1.

By traversing all the elements in the height map matrix, the value of each element is obtained, resulting in a mask matrix. The elements in the mask matrix have values of either 1 or 0. Since the elements in the mask matrix are derived from the elements of the height map matrix, the array dimensions of the mask matrix are the same as those of the height map matrix. Array dimensions refer to the length, width, and number of elements in the matrix.

During the process of converting the height map matrix to the mask matrix, if any discrepancies in matrix dimension information are found, corrections will be made.

Step S204: Determine reward function values corresponding to one or more of elements in the mask matrix with an element value of 1, wherein the element value being 1 indicates that first constraint conditions are satisfied when the target vertex of the box rests on a position corresponding to one of the elements in the height map matrix.

For the elements with value 1 in the mask matrix, the control device 102 uses the cost function of the heuristic strategy and the second constraint conditions to analyze and obtain the reward function values corresponding to the elements with value 1. For each box, the element value corresponding to the position where it can be placed is 1, that is, one box corresponds to at least one reward function value, and multiple boxes correspond to multiple reward function values.

In the embodiment, elements with a value of 1 are traversed, that is, only part of the elements in the mask matrix are traversed. Compared with traversing the entire elements in the matrix, the embodiment of the present disclosure adopts the mask matrix to reduce the computational load.

During the traversal of elements with a value of 1, the computational cost for solving the optimal solution is low due to the use of 2 cm voxelized grids. The calculation can be completed within one second by the control device.

Step S205: Determine a box number and a box placement posture corresponding to a largest reward function value of the reward function values.

The control device 102 selects the maximum reward function value from multiple reward function values, then determines the box number and the placement posture corresponding to that maximum reward function value. The placement posture refers to the box's placement position and orientation, where orientation indicates whether the box is placed horizontally or vertically. This embodiment does not include cases where the box is placed at an angle.

Step S206: Control a robotic arm to perform palletizing according to the box number and the box placement posture.

In one embodiment, the robotic arm includes an end effector (e.g., suction cup). The control device 102 controls the suction cup at the end of the robotic arm to pick up the target box corresponding to the box number. According to the placement position and orientation of the box, the robotic arm can be controlled to use simple motion planning to place the target box onto the pallet. The control device 102 then controls the robotic arm to release the suction, completing a single pick-and-place process.

In summary, the control device 102 can generate a height map matrix based on the stacking pattern. The control device 102 can traverse the elements in the height map matrix to obtain a mask matrix generated by placing a target vertex of the box on a position corresponding to each of the elements. The control device 102 can determine reward function values corresponding to one or more of elements in the mask matrix with an element value of 1. In this way, multiple reward function values are obtained for each box. The box number and placement posture corresponding to the maximum reward function value can then be identified, and the robotic arm is controlled to stack the box according to this placement posture. In the present disclosure, for boxes of unknown sizes in the incoming materials area, the placement of the boxes is determined to meet the constraint conditions through the mask matrix, ensuring the stability of the box placement.

By using the palletizing system discussed above, automatic box placement is achieved, eliminating the need for manual effort and time to determine the placement orientation of the boxes.

In one embodiment, determining the reward function values corresponding to one or more of elements in the mask matrix with the element value of 1 may include: traversing the one or more elements in the mask matrix whose element value is 1; and performing analysis using a cost function of a heuristic strategy and second constraint conditions to obtain the reward function values corresponding to the one or more elements with a value of 1.

The mask matrix contains multiple elements with a value of 1. In a hypothetical situation when a box is placed at a position corresponding to any of these elements, the box remains stable, and the robotic arm can reach the box at that position. Therefore, the position corresponding to one of these elements must be selected. The control device 102 uses a heuristic cost function and second constraint conditions to analyze the elements with a value of 1, resulting in a reward function value for each of these elements.

In one embodiment, the second constraint conditions may include one or more of conditions as follows: whether the box will be suspended in the air; whether the box will be placed close to other boxes on the pallet; whether the box will be placed on at least two other boxes on the pallet; whether the box's utilization rate of the existing surface will be greater than a preset value; whether the box's contribution to creating an upper surface is greater than a preset value; whether the total height of the stack after placing the box will be less than a preset value; and whether the stability of the stack after placing the box will exceed a stability threshold.

This present disclosure uses the second constraint conditions to consider the stability and space utilization of the boxes after they are placed, thereby improving the space utilization in stacking.

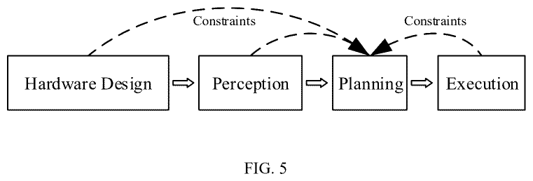

Referring to FIG. 5, in one embodiment, the control device 102 may include a processor and a storage that stores one or more executable computer programs. Exemplarily, the one or more computer programs may be divided into one or more modules/units, and the one or more modules/units are stored in the storage and executable by the processor. For example, the one or more computer programs may be divided into a perception module, a planning module and an execution module. The perception module uses two depth cameras to sense the boxes in the buffer area and the already stacked boxes on the pallet. The planning module plans to place a box in the buffer area at a certain position on the pallet and the placement direction of the box to maximize the stability of the pallet pattern and the highest space utilization rate. The execution module controls the robotic arm to stack the box from the incoming material area onto the pallet.

The present disclosure selects a box from the incoming material area and outputs its stacking position within the pallet area, ensuring that the placement of the box does not affect the overall stability of the stack. Additionally, after completing the stacking process, the space utilization is maximized.

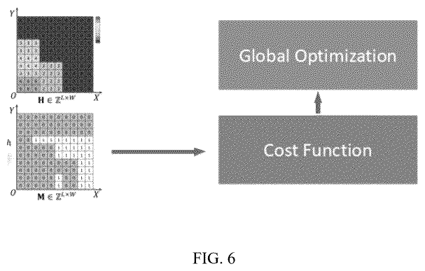

FIG. 6 is an exemplary flowchart of the planning module. Specifically, the stacking pattern is converted into a height map matrix, which is then transformed into a mask matrix. The reward function values corresponding to the elements with a value of 1 are calculated, and the maximum reward function value is determined.

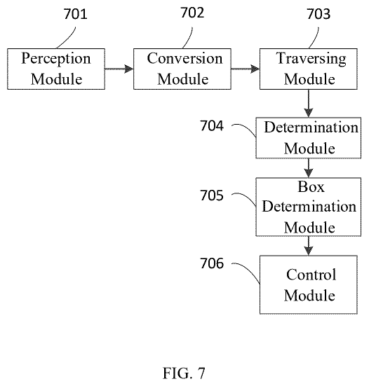

Referring to FIG. 7, in one embodiment, a palletizing device may include a perception module 701, a conversion module 702, a traversing module 703, a determination module 704, a box determination module 705 and a control module 706.

The perception module 701 is to detect, by one or more depth cameras, a size of a number of boxes in an incoming material area and a stacking pattern on a pallet. The conversion module 702 is to generate a height map matrix based on the stacking pattern. The value at each element of a plurality of elements in the height map matrix indicates a height of the stacking pattern at a position on the pallet corresponding to the element. The traversing module 703 is to traverse the boxes in the incoming material area, and for each box of the one or more boxes: traverse the elements in the height map matrix to obtain a mask matrix generated based on a hypothetical situation that a target vertex of the box rests on a position corresponding to each of the elements. The array dimensions of the mask matrix and the height map matrix are the same. The determination module 704 is to determine reward function values corresponding to one or more of elements in the mask matrix with an element value of 1. The element value being 1 indicates that first constraint conditions are satisfied when the target vertex of the box rests on a position corresponding to one of the elements in the height map matrix. The box determination module 705 is to determine a box number and a box placement posture corresponding to a largest reward function value of the reward function values. The control module 706 is to control a robotic arm to perform palletizing according to the box number and the box placement posture.

In one embodiment, the traversing module 703 is further to: in one of the hypothetical situations when the target vertex of the box rests on a position corresponding to any element of the height map matrix, determine whether the box satisfies the first constraint conditions; in response to the box satisfying the first constraint conditions, set an element value of the element to 1; in response to the box not satisfying the first constraint conditions, set the element value of the element to 0; and traverse the elements in the height map matrix to obtain the mask matrix.

In one embodiment, the first constraint conditions may include: a stacking pattern stability after placement of the box exceeding a stability threshold, the box being reachable by the robotic arm, and no colliding between the robotic arm and boxes on the pallet when the robotic arm is placing the box on the pallet.

In one embodiment, the determination module 704 is to traverse the one or more elements in the mask matrix whose element value is 1, and perform analysis using a cost function of a heuristic strategy and second constraint conditions to obtain the reward function values corresponding to the one or more elements with a value of 1.

In one embodiment, the second constraint conditions may include one or more of conditions as follows: whether the box will be suspended in the air; whether the box will be placed close to other boxes on the pallet; whether the box will be placed on at least two other boxes on the pallet; whether the box's utilization rate of the existing surface will be greater than a preset value; whether the box's contribution to creating an upper surface is greater than a preset value; whether the total height of the stack after placing the box will be less than a preset value; and whether the stability of the stack after placing the box will exceed a stability threshold.

In one embodiment, the control module 706 is to control an end effector of the robotic arm to move a target box corresponding to the box number; and control the end effector to place the target box on the pallet according to the placement posture.

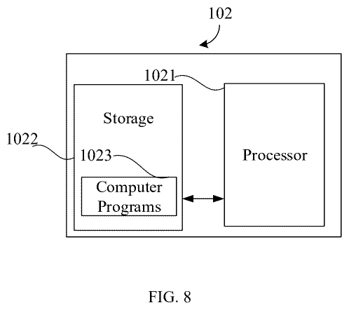

Referring to FIG. 8, in one embodiment, the control device 102 may include a processor 1021, a storage 10222, and one or more executable computer programs 1023 that are stored in the storage 10222. The storage 10222 and the processor 1021 are directly or indirectly electrically connected to each other to realize data transmission or interaction. For example, they can be electrically connected to each other through one or more communication buses or signal lines. The processor 1021 performs corresponding operations by executing the executable computer programs 1023 stored in the storage 10222. When the processor 1021 executes the computer programs 1023, the steps in the embodiments of the palletizing method discussed above are implemented.

The processor 1021 may be an integrated circuit chip with signal processing capability. The processor 1021 may be a central processing unit (CPU), a general-purpose processor, a digital signal processor (DSP), an application specific integrated circuit (ASIC), a field-programmable gate array (FPGA), a programmable logic device, a discrete gate, a transistor logic device, or a discrete hardware component. The general-purpose processor may be a microprocessor or any conventional processor or the like. The processor 1021 can implement or execute the methods, steps, and logical blocks disclosed in the embodiments of the present disclosure.

The storage 1022 may be, but not limited to, a random-access memory (RAM), a read only memory (ROM), a programmable read only memory (PROM), an erasable programmable read-only memory (EPROM), and an electrical erasable programmable read-only memory (EEPROM). The storage 1022 may be an internal storage unit of the control device 102, such as a hard disk or a memory. The storage 1022 may also be an external storage device of the control device 102, such as a plug-in hard disk, a smart memory card (SMC), and a secure digital (SD) card, or any suitable flash cards. Furthermore, the storage 1022 may also include both an internal storage unit and an external storage device. The storage 1022 is to store computer programs, other programs, and data required by the control device 102. The storage 1022 can also be used to temporarily store data that have been output or is about to be output.

Exemplarily, the one or more computer programs 1023 may be divided into one or more modules/units, and the one or more modules/units are stored in the storage 1022 and executable by the processor 1021. The one or more modules/units may be a series of computer program instruction segments capable of performing specific functions, and the instruction segments are used to describe the execution process of the one or more computer programs 1023 in the control device 102. For example, the one or more computer programs 1023 may be divided into the perception module 701, the conversion module 702, the traversing module 703, the determination module 704, the box determination module 705 and the control module 706 as shown in FIG. 7.

It should be noted that the block diagram shown in FIG. 8 is only an example of the device 102. The device 102 may include more or fewer components than what is shown in FIG. 8, or have a different configuration than what is shown in FIG. 8. Each component shown in FIG. 8 may be implemented in hardware, software, or a combination thereof.

Another aspect of the present disclosure is directed to a non-transitory computer-readable medium storing instructions which, when executed, cause one or more processors to perform the methods, as discussed above. The computer-readable medium may include volatile or non-volatile, magnetic, semiconductor, tape, optical, removable, non-removable, or other types of computer-readable medium or computer-readable storage devices. For example, the computer-readable medium may be the storage device or the memory module having the computer instructions stored thereon, as disclosed. In some embodiments, the computer-readable medium may be a disc or a flash drive having the computer instructions stored thereon.

It should be understood that the disclosed device and method can also be implemented in other manners. The device embodiments described above are merely illustrative. For example, the flowcharts and block diagrams in the accompanying drawings illustrate the architecture, functionality and operation of possible implementations of the device, method and computer program product according to embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

In addition, functional modules in the embodiments of the present disclosure may be integrated into one independent part, or each of the modules may be independent, or two or more modules may be integrated into one independent part. in addition, functional modules in the embodiments of the present disclosure may be integrated into one independent part, or each of the modules may exist alone, or two or more modules may be integrated into one independent part. When the functions are implemented in the form of a software functional unit and sold or used as an independent product, the functions may be stored in a computer-readable storage medium. Based on such an understanding, the technical solutions in the present disclosure essentially, or the part contributing to the prior art, or some of the technical solutions may be implemented in a form of a software product. The computer software product is stored in a storage medium and includes several instructions for instructing a computer device (which may be a personal computer, a server, a network device, or the like) to perform all or some of the steps of the methods described in the embodiments of the present disclosure. The foregoing storage medium includes: any medium that can store program code, such as a USB flash drive, a removable hard disk, a read-only memory (ROM), a random access memory (RAM), a magnetic disk, or an optical disc.

A person skilled in the art can clearly understand that for the purpose of convenient and brief description, for specific working processes of the device, modules and units described above, reference may be made to corresponding processes in the embodiments of the foregoing method, which are not repeated herein.

In the embodiments above, the description of each embodiment has its own emphasis. For parts that are not detailed or described in one embodiment, reference may be made to related descriptions of other embodiments.

A person having ordinary skill in the art may clearly understand that, for the convenience and simplicity of description, the division of the above-mentioned functional units and modules is merely an example for illustration. In actual applications, the above-mentioned functions may be allocated to be performed by different functional units according to requirements, that is, the internal structure of the device may be divided into different functional units or modules to complete all or part of the above-mentioned functions. The functional units and modules in the embodiments may be integrated in one processing unit, or each unit may exist alone physically, or two or more units may be integrated in one unit. The above-mentioned integrated unit may be implemented in the form of hardware or in the form of software functional unit. In addition, the specific name of each functional unit and module is merely for the convenience of distinguishing each other and are not intended to limit the scope of protection of the present disclosure. For the specific operation process of the units and modules in the above-mentioned system, reference may be made to the corresponding processes in the above-mentioned method embodiments, and are not described herein.

A person having ordinary skill in the art may clearly understand that, the exemplificative units and steps described in the embodiments disclosed herein may be implemented through electronic hardware or a combination of computer software and electronic hardware. Whether these functions are implemented through hardware or software depends on the specific application and design constraints of the technical schemes. Those ordinary skilled in the art may implement the described functions in different manners for each particular application, while such implementation should not be considered as beyond the scope of the present disclosure.

In the embodiments provided by the present disclosure, it should be understood that the disclosed apparatus (device)/terminal device and method may be implemented in other manners. For example, the above-mentioned apparatus (device)/terminal device embodiment is merely exemplary. For example, the division of modules or units is merely a logical functional division, and other division manner may be used in actual implementations, that is, multiple units or components may be combined or be integrated into another system, or some of the features may be ignored or not performed. In addition, the shown or discussed mutual coupling may be direct coupling or communication connection, and may also be indirect coupling or communication connection through some interfaces, devices or units, and may also be electrical, mechanical or other forms.

The units described as separate parts may or may not be physically separate, and parts displayed as units may or may not be physical units, may be located in one position, or may be distributed on a plurality of network units. Some or all of the modules may be selected according to actual requirements to achieve the objectives of the solutions of the embodiments.

The functional units and modules in the embodiments may be integrated in one processing unit, or each unit may exist alone physically, or two or more units may be integrated in one unit. The above-mentioned integrated unit may be implemented in the form of hardware or in the form of software functional unit.

When the integrated module/unit is implemented in the form of a software functional unit and is sold or used as an independent product, the integrated module/unit may be stored in a non-transitory computer-readable storage medium. Based on this understanding, all or part of the processes in the method for implementing the above-mentioned embodiments of the present disclosure may also be implemented by instructing relevant hardware through a computer program. The computer program may be stored in a non-transitory computer-readable storage medium, which may implement the steps of each of the above-mentioned method embodiments when executed by a processor. In which, the computer program includes computer program codes which may be the form of source codes, object codes, executable files, certain intermediate, and the like. The computer-readable medium may include any primitive or device capable of carrying the computer program codes, a recording medium, a USB flash drive, a portable hard disk, a magnetic disk, an optical disk, a computer memory, a read-only memory (ROM), a random-access memory (RAM), electric carrier signals, telecommunication signals and software distribution media. It should be noted that the content contained in the computer readable medium may be appropriately increased or decreased according to the requirements of legislation and patent practice in the jurisdiction. For example, in some jurisdictions, according to the legislation and patent practice, a computer readable medium does not include electric carrier signals and telecommunication signals.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best utilize the invention and various embodiments with various modifications as are suited to the particular use contemplated.

What is claimed is:

1. A palletizing method for unknown incoming materials, the method comprising:
detecting, by one or more depth cameras, a size of a plurality of boxes in an incoming material area and a stacking pattern on a pallet;
generating a height map matrix based on the stacking pattern, wherein a value at each element of a plurality of elements in the height map matrix indicates a height of the stacking pattern at a position on the pallet corresponding to the element;
traversing the boxes in the incoming material area, and for each box of the one or more boxes:
traversing the elements in the height map matrix to obtain a mask matrix generated based on hypothetical situations that a target vertex of the box rests on a position corresponding to each of the elements, wherein array dimensions of the mask matrix and the height map matrix are the same;
determining reward function values corresponding to one or more of elements in the mask matrix with an element value of 1, wherein the element value being 1 indicates that first constraint conditions are satisfied when the target vertex of the box rests on a position corresponding to one of the elements in the height map matrix;
determining a box number and a box placement posture corresponding to a largest reward function value of the reward function values; and
controlling a robotic arm to perform palletizing according to the box number and the box placement posture.

2. The method of claim 1, wherein traversing the elements in the height map matrix to obtain a mask matrix generated based on hypothetical situations that a target vertex of the box rests on a position corresponding to each of the elements comprises:
in one of the hypothetical situations when the target vertex of the box rests on a position corresponding to any element of the height map matrix, determining whether the box satisfies the first constraint conditions;
in response to the box satisfying the first constraint conditions, setting an element value of the element to 1;
in response to the box not satisfying the first constraint conditions, setting the element value of the element to 0; and
traversing the elements in the height map matrix to obtain the mask matrix.

3. The method of claim 2, wherein the first constraint conditions comprise: a stacking pattern stability after placement of the box exceeding a stability threshold, the box being reachable by the robotic arm, and no colliding between the robotic arm and boxes on the pallet when the robotic arm is placing the box on the pallet.

4. The method of claim 1, wherein determining the reward function values corresponding to one or more of elements in the mask matrix with the element value of 1 comprises:
traversing the one or more elements in the mask matrix whose element value is 1;
performing analysis using a cost function of a heuristic strategy and second constraint conditions to obtain the reward function values corresponding to the one or more elements with a value of 1.

5. The method of claim 4, wherein the second constraint conditions comprise one or more of conditions as follows: whether the box will be suspended in the air; whether the box will be placed close to other boxes on the pallet; and whether the box will be placed on at least two other boxes on the pallet.

6. The method of claim 1, wherein controlling the robotic arm to perform palletizing according to the box number and the box placement posture comprises:
controlling an end effector of the robotic arm to move a target box corresponding to the box number; and
controlling the end effector to place the target box on the pallet according to the placement posture.

7. A control device comprising:
one or more processors; and
a memory coupled to the one or more processors, the memory storing programs that, when executed by the one or more processors, cause performance of operations comprising:
detecting, by one or more depth cameras, a size of a plurality of boxes in an incoming material area and a stacking pattern on a pallet;
generating a height map matrix based on the stacking pattern, wherein a value at each element of a plurality of elements in the height map matrix indicates a height of the stacking pattern at a position on the pallet corresponding to the element;
traversing the boxes in the incoming material area, and for each box of the one or more boxes:
traversing the elements in the height map matrix to obtain a mask matrix generated based on hypothetical situations that a target vertex of the box rests on a position corresponding to each of the elements, wherein array dimensions of the mask matrix and the height map matrix are the same;
determining reward function values corresponding to one or more of elements in the mask matrix with an element value of 1, wherein the element value being 1 indicates that first constraint conditions are satisfied when the target vertex of the box rests on a position corresponding to one of the elements in the height map matrix;
determining a box number and a box placement posture corresponding to a largest reward function value of the reward function values; and
controlling a robotic arm to perform palletizing according to the box number and the box placement posture.

8. The control device of claim 7, wherein traversing the elements in the height map matrix to obtain a mask matrix generated based on hypothetical situations that a target vertex of the box rests on a position corresponding to each of the elements comprises:
in one of the hypothetical situations when the target vertex of the box rests on a position corresponding to any element of the height map matrix, determining whether the box satisfies the first constraint conditions;
in response to the box satisfying the first constraint conditions, setting an element value of the element to 1;
in response to the box not satisfying the first constraint conditions, setting the element value of the element to 0; and
traversing the elements in the height map matrix to obtain the mask matrix.

9. The control device of claim 8, wherein the first constraint conditions comprise: a stacking pattern stability after placement of the box exceeding a stability threshold, the box being reachable by the robotic arm, and no colliding between the robotic arm and boxes on the pallet when the robotic arm is placing the box on the pallet.

10. The control device of claim 7, wherein determining the reward function values corresponding to one or more of elements in the mask matrix with the element value of 1 comprises:
traversing the one or more elements in the mask matrix whose element value is 1;
performing analysis using a cost function of a heuristic strategy and second constraint conditions to obtain the reward function values corresponding to the one or more elements with a value of 1.

11. The control device of claim 10, wherein the second constraint conditions comprise one or more of conditions as follows: whether the box will be suspended in the air; whether the box will be placed close to other boxes on the pallet; and whether the box will be placed on at least two other boxes on the pallet.

12. The control device of claim 7, wherein controlling the robotic arm to perform palletizing according to the box number and the box placement posture comprises:
controlling an end effector of the robotic arm to move a target box corresponding to the box number; and
controlling the end effector to place the target box on the pallet according to the placement posture.

13. A non-transitory computer-readable storage medium storing instructions that, when executed by at least one processor of a control device, cause the at least one processor to perform a method, the method comprising:
detecting, by one or more depth cameras, a size of a plurality of boxes in an incoming material area and a stacking pattern on a pallet;
generating a height map matrix based on the stacking pattern, wherein a value at each element of a plurality of elements in the height map matrix indicates a height of the stacking pattern at a position on the pallet corresponding to the element;
traversing the boxes in the incoming material area, and for each box of the one or more boxes:
traversing the elements in the height map matrix to obtain a mask matrix generated based on hypothetical situations that a target vertex of the box rests on a position corresponding to each of the elements, wherein array dimensions of the mask matrix and the height map matrix are the same;
determining reward function values corresponding to one or more of elements in the mask matrix with an element value of 1, wherein the element value being 1 indicates that first constraint conditions are satisfied when the target vertex of the box rests on a position corresponding to one of the elements in the height map matrix;
determining a box number and a box placement posture corresponding to a largest reward function value of the reward function values; and
controlling a robotic arm to perform palletizing according to the box number and the box placement posture.

14. The non-transitory computer-readable storage medium of claim 13, wherein traversing the elements in the height map matrix to obtain a mask matrix generated based on hypothetical situations that a target vertex of the box rests on a position corresponding to each of the elements comprises:
in one of the hypothetical situations when the target vertex of the box rests on a position corresponding to any element of the height map matrix, determining whether the box satisfies the first constraint conditions;
in response to the box satisfying the first constraint conditions, setting an element value of the element to 1;
in response to the box not satisfying the first constraint conditions, setting the element value of the element to 0; and
traversing the elements in the height map matrix to obtain the mask matrix.

15. The non-transitory computer-readable storage medium of claim 14, wherein the first constraint conditions comprise: a stacking pattern stability after placement of the box exceeding a stability threshold, the box being reachable by the robotic arm, and no colliding between the robotic arm and boxes on the pallet when the robotic arm is placing the box on the pallet.

16. The non-transitory computer-readable storage medium of claim 13, wherein determining the reward function values corresponding to one or more of elements in the mask matrix with the element value of 1 comprises:
traversing the one or more elements in the mask matrix whose element value is 1;
performing analysis using a cost function of a heuristic strategy and second constraint conditions to obtain the reward function values corresponding to the one or more elements with a value of 1.

17. The non-transitory computer-readable storage medium of claim 16, wherein the second constraint conditions comprise one or more of conditions as follows: whether the box will be suspended in the air; whether the box will be placed close to other boxes on the pallet; and whether the box will be placed on at least two other boxes on the pallet.

18. The non-transitory computer-readable storage medium of claim 13, wherein controlling the robotic arm to perform palletizing according to the box number and the box placement posture comprises:
controlling an end effector of the robotic arm to move a target box corresponding to the box number; and
controlling the end effector to place the target box on the pallet according to the placement posture.
